(19) United States
(12) Patent Application Publication
(10) Pub. No.: US 2012/0296994 A1
(43) Pub. Date: Nov. 22, 2012

(54) METHOD FOR INTEGRATING COMMUNICATION SERVICE WITH MULTI-PLAYER APPLICATIONS

(76) Inventor: Nikola Borisov, Palo Alto, CA (US)

(21) Appl. No.: 13/475,566

(22) Filed: May 18, 2012

Related U.S. Application Data
(60) Provisional application No. 61/487,499, filed on May 18, 2011.

(51) Int. Cl. G06F 15/16

(52) U.S. Cl. 709/206

(57) ABSTRACT

A method provides users of a communication service access to a third party application over a wide area network. The method includes (a) receiving from one of the users a request for access to the third party application; (b) over a predetermined application program interface, sending a message to a server hosting the third party application indicating the request for access; (c) receiving from the server one or more resource locators for use by the users to access the third party application; and (d) distributing the resource locators to the users. The third party application may be a game, for example. Upon receiving the message, the server of the third party application initiates the game. The application program interface may be provided through a POST command under the hypertext transport protocol. In addition, parameters for the third party application may be specified in the POST command.

### CROSS REFERENCE TO RELATED APPLICATIONS

The present application relates to and claims priority of U.S. Provisional Patent Application (“Provisional Application”), Ser. No. 61/487,499, entitled “Method for Integrating Communication Service with Multi-Player Applications,” filed on May 18, 2011. The Provisional Patent Application is hereby incorporated herein by reference in its entirety.

### BACKGROUND OF THE INVENTION

1. Field of the Invention

The present invention relates to enabling multi-party applications over a computer network. In particular, the present invention relates to integrating multi-party games and applications with communication services, such as those communication services provided by social networking applications,

2. Discussion of the Related Art

Many game websites offer free multi-player, on-line games. However, to play such a game exclusively with friends requires a lot of effort. Often times the process involves having each player create an account at the on-line game site, having the players coordinate with each other to enter the same virtual game room, creating a private game with a password, and going through an invitation procedure to include other friends in the game. The process may have to be repeated at each game site for each game the players want to play. At the same time, even for a simple online game, a game developer's job in creating the necessary process is not simple. This is because, to support the set-up procedures, the game developer has to implement modules for account authentication, virtual rooms, private games, buddy lists and other elements.

### SUMMARY

According to one embodiment of the present invention, an application program interface (“API”) allows a third-party, multi-player game or application to be integrated into a communication service, such as an instant messaging service for social networking clients.

According to one embodiment of the present invention, a method provides users of a communication service access to a third party application over a wide area network. The method includes, at the communication service provider, (a) receiving from one of the users a request for access to the third party application; (b) over a predetermined application program interface, sending a message to a server hosting the third party application, the message indicating the user's request for access; (c) receiving from the server one or more resource locators for use by the users to access the third party application; and (d) distributing the resource locators to the users. The third party application may be a game, for example. Upon receiving the message indicating the user's request for access, the server of the third party application initiates the game. The application program interface may be provided through a POST command under the hypertext transport protocol (“http”). In addition, parameters for the third party application may be specified in the POST command under http.

Thus, according to one embodiment of the present invention, a game provider may implement the API to be invoked by a communication service (e.g., instant messaging service) when one or more users wish to initiate a game among themselves or with other friends.

The present invention relieves a game developer from the burden of overhead tasks (e.g., having to create an authentication module), and thereby facilitates a broader user access to the game developer's games. As a result, the game developer is able to focus on the creating the game experience, while developers of a communication or social networking application can focus on providing better messaging services, for example. Such an API also allows the game developers to publish their games to users of multiple communication or social networking services, and it also enables the social platforms to have multiple game providers for a particular game (e.g., chess or card games). The API defines the communication mechanism provided under the present invention to establish a multi-player game between a game website (i.e., the ‘game provider’) and a communication or social networking client (i.e., software that accesses the friend/buddy list of the user and is able to communicate with them).

The present invention is better understood upon consideration of the detailed description below.

### BRIEF DESCRIPTION OF THE DRAWINGS

FIG. 1 illustrates system 100, including communication service 101, game site 102 and users 103 and 104, suitable for implementing an embodiment of the present invention.

FIG. 2 illustrates the process by which users 103 and 104 may play a game among themselves, according to one embodiment of the present invention.

### DETAILED DESCRIPTION OF THE PREFERRED EMBODIMENTS

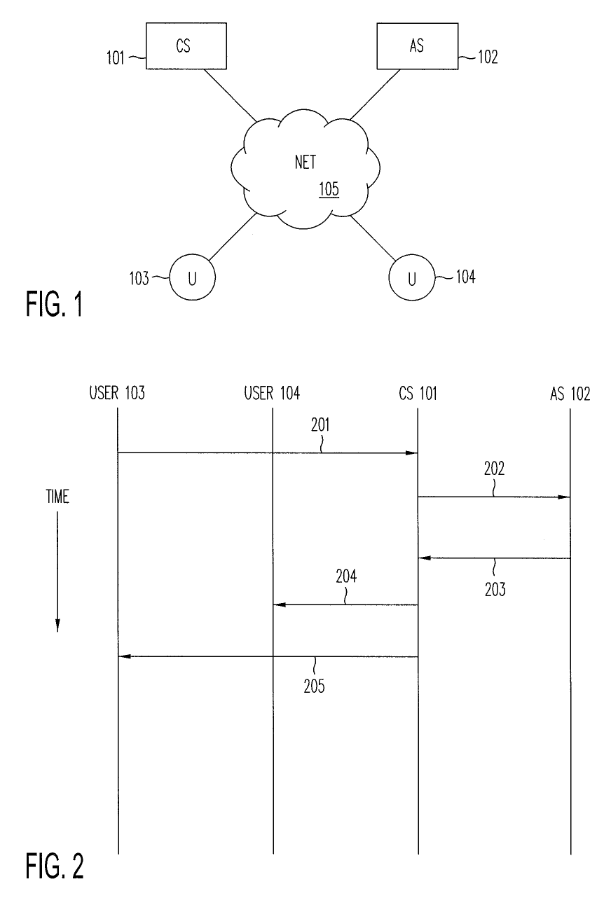

FIG. 1 illustrates system 100, which includes communication service 101, game site 102 and users 103 and 104 interconnected by wide area computer network 105 (e.g., the Internet), suitable for implementing an embodiment of the present invention. As shown in FIG. 1, communication service 101 represents a server for a social network site (e.g., imo.im) providing communication services to users 103 and 104. An example of such communication services may be, for example, a chat service. Game site 102 may represent a server of a game provider that hosts multi-player games (e.g., chess).

To allow users of communication service 101 to initiate a game, the game provider at game site 102 implements an API. One example of a suitable game site for the method described herein may be “lichess.org,” which is an on-line chess game provider. The API may be accessed, for example, by communication service 101 making an hypertext transport protocol (“http”) request to game site 102 using a predetermined universal resource locator (“URL”) pointing to the API. Normally, game site 102 would have registered the game as an approved game with communication service 101, The approval process may require a review by communication service 101 to ensure the game to be suitable for its users. Such review process may screen out inappropriate subject matter (e.g., crude, offensive, pornographic, excessively violent, illegal or mean-spirited subject matter), for example. The review may also screen out malicious software that may breach security or otherwise injure communication service 101′s users (e.g., links to viruses or software that inappropriately intrude into user privacy). Upon approval, communication service 101 allows its users access to the game through its user interface. For example, a user may select the game by selecting a radio button or from a menu presented in the user interface by communication service 101.

FIG. 2 illustrates the process by which users 103 and 104 may play a game among themselves, according to one embodiment of the present invention. Initially, users 103 and 104 are holding a chat session. At some point during the chat session, user 103 and user 104 agree to play a game of chess. As shown in FIG. 2, user 103 selects the game from its user interface, resulting in message 201 being sent to communication service 101. Message 201 indicates to communication service 101 that user 103 would like to initiate the game with user 104. The number of players to be included in the game may be expressly or implicitly specified. In response, communication service 101 invokes the API at game site 102 by sending message 202, which requests game site 102 to create the game. Message 202 may take the form, for example, of an http POST command:
POST http://lichess.org/chess/create

Additional options may be passed to game site 102 as part of the HTTP POST command to specify the requested game's configuration and other parameters. For example, such options may be: ‘player1_color=white&game_type=blitz’, specifying a chess game in which “player 1” plays white and the game is a timed/speed game.

In response to message 202, game site 102 sets up an instance of the game and returns to communication service 101 in message 203 two or more program access objects for the instance of the game (e.g., URLs that are to be used by the players to access the game). Message 203 may encapsulate, for example, a collection of URLs:

{‘player1_url’: ‘http://lichess.org/Jn03Hs’,

‘player2_url’: ‘http://lichess.org/Ndhw82’}

Upon receiving the program access objects, communication service 101 distributes the objects to users 103 and 104 in messages 204 and 205. Users 103 and 104 will then use their respective program access objects to play the game.

In games that involve an arbitrary number of players, or more than a predetermined number of players, game site 102 may return only a single URL, which is then distributed by communication service 101 to the players (or distributed by user 103 to the other players). In that case the player admission, role assignment, game options or other processes required for the game may occur when players access the game using the common, single URL.

Thus, the present invention provides a method by which users of a communication service may initiate and participate in a game served from a third-party site with as minimal action as a single click of a mouse (e.g., selecting the game/application title from library/store) and without requiring these users to go through a registration process and finding their friends' game. In addition, under the present invention, the game provider need not require the users to download any software

The above detailed description is provided to illustrate specific embodiments of the present invention and is not intended to be limiting. Numerous variations and modifications within the scope of the present invention are possible. The present invention is set forth in the accompanying claims.

We claim:

1. At communication service provider, a method for providing one or more users access to a third party application over a wide area network, comprising:
receiving from one of the users a request for access to the third party application;
over a predetermined application program interface, sending a message to a server hosting the third party application, the message indicating the user's request for access;
receiving from the server one or more resource locators for use by the users to access the third party application; and
distributing the resource locators to the users.

2. The method of claim 1, wherein the third party application comprises a game, and wherein, upon receiving the message, the server initiates the game.

3. The method of claim 1, wherein the application program interface is provided through a POST command under the hypertext transport protocol.

4. The method of claim 1, wherein parameters for the third party application are specified in the POST command.

5. The method of claim 1, wherein the resource locators are universal resource locators used in conjunction with the hypertext transport protocol.

6. The method of claim 1, wherein the users are users in a communication service.

7. The method of claim 6, wherein the communication service includes a chat service.

8. The method of claim 1, wherein the request for access is sent as a result of selecting a program object in a user interface.
